(19) United States
(12) Patent Application Publication
(10) Pub. No.: US 2009/0314905 A1
(43) Pub. Date: Dec. 24, 2009

(54) Irrigation system hose support

(75) Inventors: Davis T. Bradberry, Clermont, FL (US); LaErik Cooper, Orlando, FL (US)

Correspondence Address: William M. Hobby, III, Suite 375, 157 E. New England Avenue, Winter Park, FL, 32789, US

(73) Assignee: Senninger Irrigation Inc.

(21) Appl. No.: 12/214,739

(22) Filed: Jun. 23, 2008

(51) Int. Cl. B05B 15/06

(52) U.S. Cl. 248/75

(57) ABSTRACT

A hose support for supporting a drop hose in an irrigation system includes a curved hose support body having a generally U-shaped cross-section for supporting a drop hose therein. A water conduit coupling has one end threaded for attaching to a central irrigation water conduit and is fixedly attached to one end of the curved hose support body. The water conduit coupling has a drop hose coupling extending from the other end thereof and extending into the curved hose support body for attaching the drop hose to the water conduit coupling into the central irrigation water conduit. This allows a hose support for a drop hose to be attached to an irrigation system water conduit and a drop hose attached thereto and supported therein.

### BACKGROUND OF THE INVENTION

This present invention relates to a hose support and especially to a hose support for supporting a drop hose in an irrigation system.

Mechanically moved irrigation systems are commonly used throughout the United States for irrigating agricultural lands. Generally the mechanically moved irrigation system includes a plurality of wheeled towers supporting a linear water conduit in a manner that the wheeled towers and water conduit can be moved through an agricultural field changing the position of the irrigation sprinklers coupled to the water conduit. One end of the water conduit is coupled to a water main or well and the sprinkler heads are mounted in spaced alignment along the water conduit between the wheeled towers. The irrigation system may be moved in an agricultural field by a motor coupled through a gear box to the wheels of the towers.

One type of mechanically moved irrigation system in common use is a center pivot irrigation system used in the irrigation of large fields. These typically are comprised of a linear water conduit which is pivotally connected at one end to a source of water under pressure. The water conduit is carried in an elevated positioned by a plurality of spaced wheeled towers which are powered by hydraulic, pneumatic or electric motors to rotatably sweep the central conduit over a central pattern in a field. The central conduit includes a plurality of water sprinkler heads spaced over its length for distributing a spray of water on the circular field area as the center pivot irrigation conduit passes thereby. The center pivot and other wheeled line irrigation systems have been successful for a uniform distribution of water over a field crop.

The current practice in some irrigation systems is to connect drop hoses to the water main with conventional couplings and then have the hoses drop near the field below and then have sprinkler nozzles attached to the end thereof for distributing the water adjacent the crops.

The present invention is directed towards the attachment of drop hoses to an irrigation water line of a wheeled irrigation system to both connect the drop hose to the water line and to support it on the water line while holding it in place facing downward from the water line. One past irrigation system by the present Applicant is the Healy U.S. Pat. No. 6,745,985 for a wheeled line irrigation system having a water main supported on a plurality of towers and having a truss built of truss rods attached to the water main to support a plurality of drop hoses connected to the water main over the trusses for distribution of irrigation water from an irrigation system to the crops below. The truss uses a rod hose sling attached to the truss rod and to the hose for holding the hose to the truss rod and to guide the hose over the truss rod.

In contrast, the present invention is a direct connection to the irrigation system water main supported on a plurality of towers but provides a connection for the drop hose to the water main while simultaneously providing a hose support or saddle with a curved supporting channel to support the hose from the top of the water main in a curved fashion for a clean drop to the field below.

### SUMMARY OF THE INVENTION

A hose support for a drop hose of an irrigation system includes a curved hose support body having a generally arcuate U-shaped cross-section for supporting a drop hose therein. A water conduit coupling has one end threaded for attaching to a central irrigation water conduit and is fixedly attached to one end of the curved hose support body. The water conduit coupling has a drop hose coupling extending from the other end thereof and extending into the curved hose support body for attaching the drop hose to the water conduit coupling and into the central irrigation water conduit. This allows a hose support for a drop hose to be attached to an irrigation system water conduit and a drop hose attached thereto and supported therein. The curved hose support body has a drop hose holding ring at the other end thereof for sliding the drop hose therethrough for attaching to the drop hose coupling. The curved hose support body has a pair of openings therein adjacent the top hose coupling to assist in attaching the drop hose to the drop hose coupling. The curved hose support body is a generally arcuate support body or saddle having a generally gooseneck shape having a generally U-shaped cross-section. The curved hose support body also has a bracing rib thereunder.

### BRIEF DESCRIPTION OF THE DRAWINGS

Other objects, features, and advantages of the present invention will be apparent from the written description and the drawings in which:

FIG. 1 is a perspective view of a drop hose water main attachment and support in accordance with the present invention;

FIG. 2 is a side elevation of the drop hose support of FIG. 1;

FIG. 3 is a front side elevation of the drop hose support of FIGS. 1 and 2;

FIG. 4 is a top plan view of the drop hose support of FIGS. 1 through 3;

FIG. 5 is a perspective view of a pair of drop hose supports of FIGS. 1 through 4 mounted to a water main;

FIG. 6 is a drop hose support attached to a water main and having a drop hose attached thereto; and

FIG. 7 is a side elevation of the drop hose support of FIGS. 1 through 6 attached to a water main and having a drop hose being attached to the drop hose coupler.

### DETAILED DESCRIPTION OF THE PREFERRED EMBODIMENT

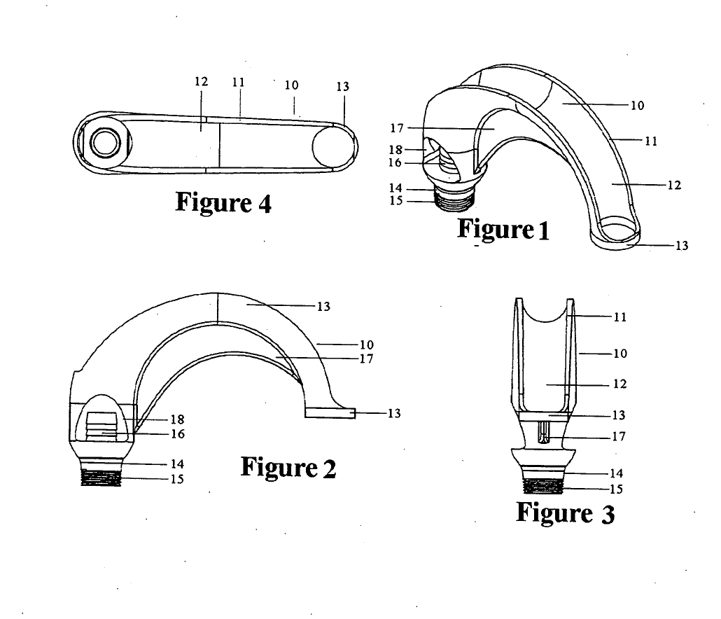

Referring to the drawings, FIGS. 1 through 7, a drop hose support and water main attachment 10 has a generally U-shaped or arcuate or gooseneck shaped body 11 having a curved channel 12 for supporting a drop hose therein. The generally U-shaped body can be about 180 degrees but can be greater or less than 180 degrees as required in special situations. The drop hose support 11 has a ringed end portion 13 for holding a drop hose therein. A water conduit coupling 14 is attached to the curved hose support body 11 and has a threaded end 15 which can be threadedly attached to an irrigation water main for supporting the hose support body 11. The water conduit coupling 14 also has a hose connection coupling 16 extending into the curved hose support body 11 for attaching a hose thereto. The curved hose support body 11 can also be seen as having a bracing rib 17 mounted underneath the curved grooved hose support 12, sometimes referred to herein as a saddle. The body 11 has side openings 12 on either side thereof adjacent the hose coupling 16 for better access and visibility of the hose coupling 16 during the attachment of a drop hose thereto.

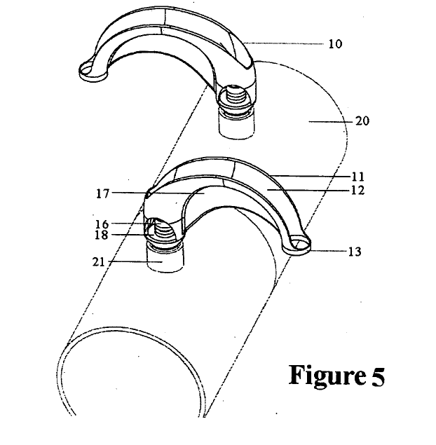

The drop hose support for an irrigation system is more clearly seen in FIG. 5 being attached to an irrigation water main 20, such as found in a wheeled line irrigation system or a center pivot irrigation system. Each drop hose support water conduit coupling 14 has a threaded end 15 threaded into the threaded openings 21 of the water main 20.

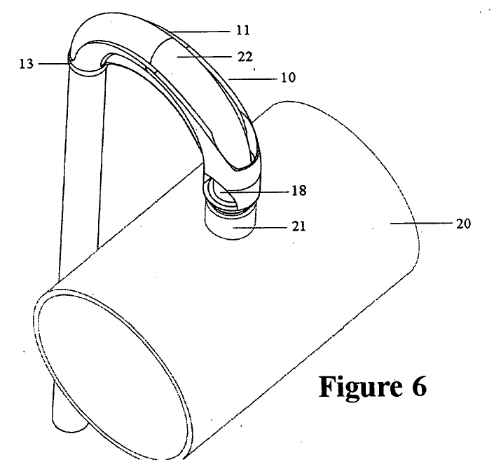

As more clearly seen in FIG. 6, an irrigation drop hose 22 is seen attached to the water conduit coupling and extending around the support 12, which may have a generally U-shaped cross-section to form a channel therein and through the holding ring 13. The drop hose 22 is thus attached to the water main through the water conduit coupling forming a part of the hose support and is held in a smooth arcuate support channel and held in a downward position by the holding ring 13.

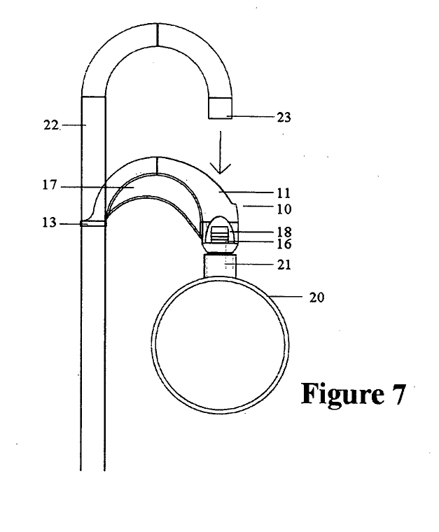

FIG. 7 illustrates the drop hose support 10 attached to the irrigation water main 20 at the coupling 21 and showing the drop hose water connection 16 through the openings 18 with the curved hose support body 11 being further braced by the support rib 17. In this view, the drop hose 22 is shown inserted through the holding ring 13 with the end of the drop hose 23 being pulled down for attachment to the drop hose coupling 16.

It should be clear at this point that a drop hose support has been provided which advantageously attaches to the conventional threaded attachment on an irrigation water main and provides an attachment for the drop hose to the irrigation water main and holds the drop hose in an advantageous curve from the top of the water main to a vertical direction downward for connection with a sprinkler head at the other end of the drop hose 22. This allows the rapid attachment of a drop hose to the water main and provides support to prevent crimping and wear in the water drop hose while holding the drop hose in a generally vertical direction. However, the present invention should not be considered as limited to the forms shown which are to be considered illustrative rather than restrictive.

We claim:

1. A hose support for a drop hose of an irrigation system comprising:
a curved hose support body having a generally U-shaped cross-section for supporting a drop hose therein;
a water conduit coupling having one end threaded for attaching to a central irrigation water conduit and being fixedly attached to one end of said curved hose support body, said water conduit coupling having a drop hose coupling extending from the other end thereof and extending into said curved hose support body for attaching a drop hose thereto when said drop hose is riding in said curved hose support body;
whereby a hose support for a drop hose can be attached to an irrigation system central water conduit and a drop hose attached thereto and supported therein.

2. The hose support for a drop hose of an irrigation system in accordance with claim 1 in which said curved hose support body has drop hose holding ring on the other end thereof for sliding said drop hose therethrough for attaching to said drop hose coupling.

3. The hose support for a drop hose of an irrigation system in accordance with claim 2 in which said curved hose support body has a pair of openings therein adjacent said drop hose coupling.

4. The hose support for a drop hose of an irrigation system in accordance with claim 2 in which said curved hose support body is a generally arcuate support body.

5. The hose support for a drop hose of an irrigation system in accordance with claim 4 in which said curved hose support body has a supporting rib thereunder.

6. The hose support for a drop hose of an irrigation system in accordance with claim 5 in which said water conduit coupling is part of said curved hose support body.

7. The hose support for a drop hose of an irrigation system in accordance with claim 6 in which said hose support body and water conduit coupling are a molded polymer unit.

8. The hose support for a drop hose of an irrigation system in accordance with claim 6 in which said hose support is formed as a unit.

9. A hose support for a drop hose of an irrigation system comprising:
a curved hose saddle having a generally open arcuate cross-section for supporting a drop hose therein, said hose saddle having a threaded water conduit coupling attached to one end thereof for threadedly attaching to a central irrigation water conduit and having a drop hose coupling extending therefrom into said hose saddle for attaching a drop hose thereto when said drop hose is riding in said curved hose saddle; whereby a hose support can be attached to an irrigation system water conduit and a drop hose supported therein and connected to said central water conduit.

10. The hose support for a drop hose of an irrigation system in accordance with claim 9 in which said curved hose saddle has drop hose holding ring on the other end thereof for holding a drop hose in the curved hose saddle.

11. The hose support for a drop hose of an irrigation system in accordance with claim 10 in which said curved hose saddle has a pair of openings therein adjacent said drop hose coupling extending into said curved hose saddle.

12. The hose support for a drop hose of an irrigation system in accordance with claim 11 in which said curved hose saddle is generally gooseneck shaped with an open side.

13. The hose support for a drop hose of an irrigation system in accordance with claim 12 in which said curved hose saddle has a supporting rib thereunder.

14. The hose support for a drop hose of an irrigation system in accordance with claim 13 in which said curved hose saddle having a water conduit coupling is a molded polymer hose saddle.
